(19) United States
(12) Patent Application Publication
(10) Pub. No.: US 2023/0124478 A1
(43) Pub. Date: Apr. 20, 2023

(54) RAPIDLY SINTERED CATHODES WITH OPTIMAL SIZE AND CONCENTRATION OF SECONDARY PHASES AND METHODS OF FORMATION THEREOF

(71) Applicant: CORNING INCORPORATED, CORNING, NY (US)

(72) Inventors: Sumitava De, Waltham, MA (US); Cameron Wayne Tanner, Horseheads, NY (US)

(21) Appl. No.: 17/915,665

(22) PCT Filed: Mar. 26, 2021
(86) PCT No.: PCT/US2021/024317

§ 371 Date: Sep. 29, 2022

Related U.S. Application Data
(60) Provisional application No. 63/004,136, filed on Apr. 2, 2020.

(51) Int. Cl. H01M 4/36; H01M 4/58; H01M 10/0563; H01M 4/04

(52) U.S. Cl. CPC H01M 4/364; H01M 4/5825; H01M 10/0563; H01M 4/0471; H01M 2004/021

(57) ABSTRACT

A sintered electrode for a battery, the sintered electrode having a first surface positioned to face a current collector and a second surface positioned to face an electrolyte layer, such that the sintered electrode includes: a first phase and a second phase, such that: the first phase has a lithium compound, and the second phase has at least one of a porous structure or solid-state Li-ion conductors, and such that: a thickness of the sintered electrode between the first surface and the second surface ranges between 10 μm and 200 μm.

This application claims the benefit of priority under 35 U.S.C. § 119 of U.S. Provisional Application Ser. No. 63/004,136, filed on Apr. 2, 2020, the content of which is relied upon and incorporated herein by reference in its entirety.

### BACKGROUND

### 1. Field

This disclosure relates to rapidly sintered cathodes with optimal size and concentration of secondary phases.

### 2. Technical

Efforts to increase energy density of lithium ion (Li-ion) batteries are being pursued using solid-state (SS) battery structures having lithium (Li) metal anodes. The theoretical charge capacity of Li metal is about 10-fold greater than graphitic carbon, the latter which is used in conventional Li-ion batteries. Current efforts to develop SS Li-batteries have been focused on development of materials with high Li-ion conductivity to minimize internal cell resistances for rapid charging and discharging.

Slow rates of Li-ion conduction in current cathode materials limits usable capacity, restricts charging speed and ability to deliver sustained power, and makes fabrication of batteries with an absolute capacity target cumbersome and expensive.

The present application discloses improved cathodes and methods of formation thereof for Li-ion battery applications.

### SUMMARY

In some embodiments, a sintered electrode for a battery, the sintered electrode having a first surface positioned to face a current collector and a second surface positioned to face an electrolyte layer, wherein the sintered electrode comprises: a first phase and a second phase, wherein: the first phase comprises a lithium compound, and the second phase comprises at least one of a porous structure or solid-state Li-ion conductors, and wherein: a thickness of the sintered electrode between the first surface and the second surface ranges between 10 μm and 200 μm.

In one aspect, which is combinable with any of the other aspects or embodiments, the second phase comprises the porous structure, wherein: the sintered electrode having an open porosity in a range of 5% to 35%, and the porous structure is continuous within the first phase.

In one aspect, which is combinable with any of the other aspects or embodiments, pores of the porous structure are aligned, on average, to within 25° of perpendicular to the first and the second surfaces of the sintered electrode.

In one aspect, which is combinable with any of the other aspects or embodiments, the porous structure is infiltrated with a liquid electrolyte.

In one aspect, which is combinable with any of the other aspects or embodiments, the liquid electrolyte comprises at least one of lithium hexafluorophosphate (LiPF₆), lithium tetrafluoroborate (LiBF₄), lithium bisoxalto borate (LiBOB), lithium difluorooxalto borate (LiDFOB), lithium trifluorosulfonylimide (LiTFSI) or combinations thereof.

In one aspect, which is combinable with any of the other aspects or embodiments, the second phase comprises the solid-state Li-ion conductors present in a range of 5% to 35% by volume of the sintered electrode.

In one aspect, which is combinable with any of the other aspects or embodiments, the solid-state Li-ion conductors have a lithium ion conductivity exceeding 10⁻⁴ S/cm.

In one aspect, which is combinable with any of the other aspects or embodiments, the solid-state Li-ion conductors are at least one of: lithium garnet (LLZO), lithium borate (LBO), lithium lanthanum titanate (LTO), lithium aluminum titanium phosphate (LATP), lithium aluminum germanium phosphate (LAGP), Li₁₁AlP₂Si₂, lithium phosphosulfide (LPS), combinations thereof, or doped variations thereof.

In one aspect, which is combinable with any of the other aspects or embodiments, the lithium compound comprises at least one of lithium cobaltite (LCO), lithium nickel manganese cobaltite (NMC), lithium manganite spinel, lithium nickel cobalt aluminate (NCA), lithium iron manganite (LMO), lithium iron phosphate (LFP), lithium cobalt phosphate, lithium nickel manganate, lithium titanium sulfide, or combinations thereof.

In one aspect, which is combinable with any of the other aspects or embodiments, the sintered electrode is a self-supporting substrate of the battery.

In one aspect, which is combinable with any of the other aspects or embodiments, the battery does not comprise an inactive substrate.

In one aspect, which is combinable with any of the other aspects or embodiments, a perimeter-to-surface area ratio between the first phase and the second phase is at least 0.4 μm⁻¹.

In one aspect, which is combinable with any of the other aspects or embodiments, a cross-sectional area of the sintered electrode is at least 3 cm².

In some embodiments, a cathode for a battery, comprises: a first phase and a second phase; and a first surface and a second surface, wherein a thickness between the first surface and the second surface is between 10 μm and 200 μm; and wherein the cathode has at least one of: an open porosity in a range of 5% to 35%; a lithium ion conductivity exceeding 10⁻⁴ S/cm; and a perimeter-to-surface area ratio between the first phase and the second phase of at least 0.4 μm⁻¹.

In one aspect, which is combinable with any of the other aspects or embodiments, a cross-sectional area of the sintered cathode is at least 3 cm².

In one aspect, which is combinable with any of the other aspects or embodiments, a battery, comprises: the cathode of any embodiment described herein; an electrolyte material penetrating a porous region of the cathode; wherein the cathode is a substrate of the battery.

In one aspect, which is combinable with any of the other aspects or embodiments, the electrolyte is selected from: lithium hexafluorophosphate (LiPF₆), lithium tetrafluoroborate (LiBF₄), lithium bisoxalto borate (LiBOB), lithium difluorooxalto borate (LiDFOB), lithium trifluorosulfonylimide (LiTFSI) or combinations thereof; lithium garnet (LLZO), lithium borate (LBO), lithium lanthanum titanate (LTO), lithium aluminum titanium phosphate (LATP), lithium aluminum germanium phosphate (LAGP), Li₁₁AlP₂S₁₂, lithium phosphosulfide (LPS), combinations thereof, or doped variations thereof.

In one aspect, which is combinable with any of the other aspects or embodiments, the battery does not include an inactive substrate.

In one aspect, which is combinable with any of the other aspects or embodiments, a volume of the battery is less than a volume of a battery comprising a cathode disposed over the inactive substrate.

It is to be understood that both the foregoing general description and the following detailed description are merely exemplary and are intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and the operation of the various embodiments.

FIG. 1 illustrates volumetric energy density and maximum C-rate capability as a function of LCO cathode thickness for LiPON electrolyte (1 μm) and LLZO electrolyte (20 μm).

FIG. 2 is a schematic, cross-sectional view depicting a Li-ion battery having a sintered cathode, according to some embodiments.

FIG. 3 is a schematic, cross-sectional view of a conventional Li-ion battery.

FIG. 4 is graph of the charge capacity of the battery of FIG. 2 as compared to the charge capacity of the battery of FIG. 3.

FIGS. 5-8 are scanning electron microscopy (SEM) images of polished cross-sections of samples E1-E4, respectively, according to some embodiments.

FIG. 9 illustrates charging capacity as a function of charging speed for samples E1-E4, according to some embodiments.

FIG. 10 illustrates charging capacity at 1 C rate as a function of perimeter-to-surface area ratio at nominally constant porosity for samples E1-E4, according to some embodiments.

FIG. 11 illustrates modeled capacity at 1 C rate for a 67 μm thick LCO electrode as a function of concentration of conducting secondary phase with a conductivity of 1M LiPF₆ in organic carbonate solution.

FIG. 12 illustrates modeled capacity at 1 C rate for a sintered LCO cathode as a function of lithium-ion conductivity of the second phase, according to some embodiments.

### DETAILED DESCRIPTION

Reference will now be made in detail to exemplary embodiments which are illustrated in the accompanying drawings. Whenever possible, the same reference numerals will be used throughout the drawings to refer to the same or like parts. The components in the drawings are not necessarily to scale, emphasis instead being placed upon illustrating the principles of the exemplary embodiments. It should be understood that the present application is not limited to the details or methodology set forth in the description or illustrated in the figures. It should also be understood that the terminology is for the purpose of description only and should not be regarded as limiting.

Additionally, any examples set forth in this specification are illustrative, but not limiting, and merely set forth some of the many possible embodiments of the claimed invention. Other suitable modifications and adaptations of the variety of conditions and parameters normally encountered in the field, and which would be apparent to those skilled in the art, are within the spirit and scope of the disclosure.

As stated earlier, current efforts to develop SS Li-batteries have been focused on development of ceramic electrolyte materials with high Li-ion conductivity to minimize internal cell resistances for rapid charging and discharging. Cubic lithium garnet (LLZO), aluminum-doped lithium titanium phosphate (LATP), and others have bulk Li-ion conductivity exceeding 10⁻⁴ S/cm, and when having a thickness less than 50 μm, contribute area-specific battery resistances of less than 50 Ω·cm², where the area-specific resistance is defined as the thickness of the electrolyte region divided by its lithium ion conductivity. As a comparison, traditionally used lithium phosphorus oxynitride (LiPON) has a conductivity of only 2×10⁻⁶ S/cm.

Rates of lithium transport in cathode materials tend to be slower than in electrolyte. Table 1 describes transport parameters for archetype lithium battery cathode materials.

TABLE 1

| | Chemical Diffusion | | |
|---|---|---|---|
| Cathode | Coefficient | Conductivity (S/cm) | |
| Material | D_{c} (cm²/s) | Ionic, σ_{Li+} | Electronic, σₑ₋ |
| Li₁₋ₓCoO₂ | a-axis: 2.5 × 10⁻¹² to 2.5 × 10⁻¹¹ | a-axis: 1 × 10−⁷ to 5 × 10⁻⁷ | a-axis: >3.3 × 10⁻² |
| (LCO) | c-axis: 1 × 10⁻¹³ to 6.3 × 10⁻¹³ | c-axis: 5 × 10⁻¹⁰ to 1.6 × 10⁻⁷ | c-axis: >1 × 10⁻⁴ |
| Li₁₋ₓMn₂O₄ | 2 × 10⁻¹² to 8 × 10⁻¹¹ | 1 × 10⁻⁶ to 3 × 10⁻⁶ | >1 × 10⁻⁷ to 1 × 10⁻⁶ |
| (LMO) | | | |
| LiFePO₄ | a-axis: 8 × 10⁻⁵ | 2 × 10⁻⁵ | 2 × 10⁻⁹ |
| (LFP) | b and c axis: 2.2 × 10⁻⁵ | | |

Li-ion conductivities for LCO, LMO, and LFP are significantly lower than ceramic electrolytes like LLZO and LATP (>10⁻⁴ S/cm). Li-ion conduction in LCO and LFP, after factoring the limitation of slow electronic conduction, is lower than LiPON. Among those in Table 1, only LMO is comparable in Li-ion conduction to LiPON. Thus, as a result of slow Li-ion conductivities, cathode materials are limited in usable capacity, charging speed, and the ability to deliver sustained power, thereby making fabrication of batteries with an absolute capacity target cumbersome and expensive.

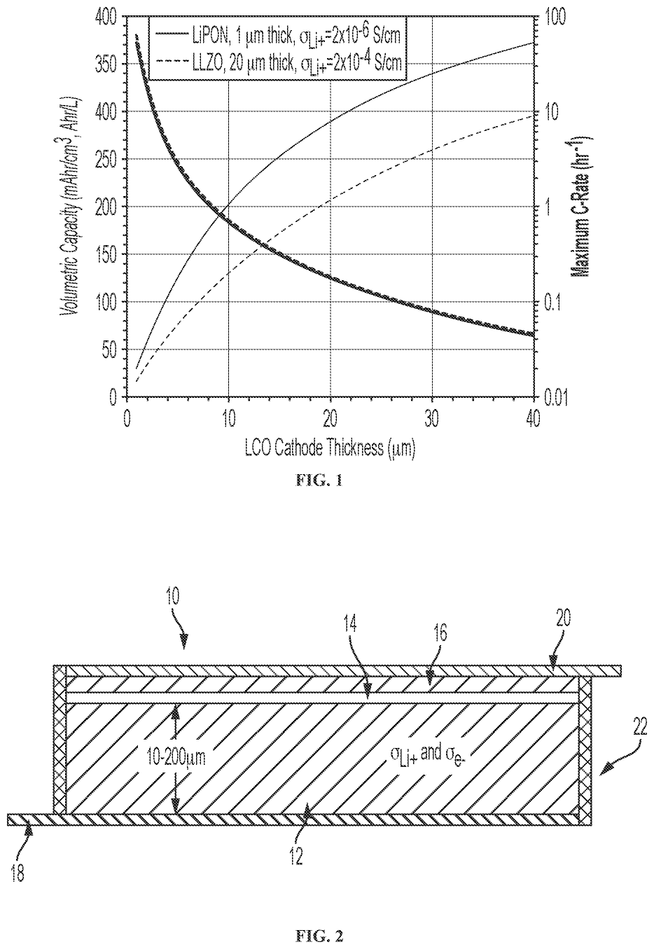

Not to be bound by theory, material of a cathode that is beyond a threshold distance from its interface with the electrolyte is not accessible—i.e., Li-ion conduction rate is dependent on the threshold distance, which itself is a function of cathode thickness. In other words, thicker cathodes increase the likelihood that material in a cathode is beyond a threshold distance from the cathode-electrolyte interface, reducing Li-ion conduction rate. On the other hand, if the cathode is too thin, inactive materials (such a substrate underlying the cathode) may also limit energy density. FIG. 1 illustrates volumetric energy density and maximum charge rate (C-rate) capability of an LCO cathode as a function of thickness. Similar trends are observed whether the electrolyte is LiPON (1 μm) or LLZO (20 μm): as cathode thickness increases, maximum C-rate decreases which volumetric energy density increases. For the battery structures tested in FIG. 1, current collectors are copper (Cu) and aluminum (Al), each with a thickness of 10 μm; the total charge transfer resistances are identical (20 Ω·cm²) in both the LiPON electrolyte containing battery and the LLZO electrolyte containing battery; and the maximum C-rate is estimated from the ohmic current density that yields a potential drop of 1V.

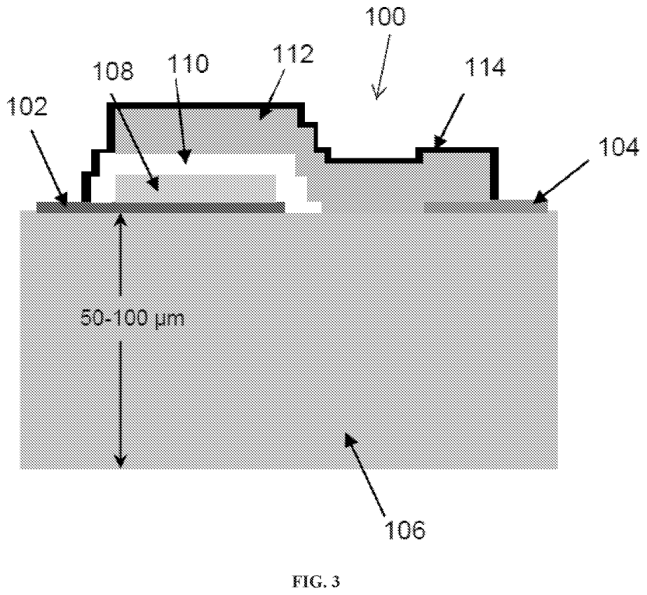

For many electronic devices, a target charge time of at most 1 hr provides an ambitious goal for cathode capabilities and attributes. From FIG. 1, it is seen that to meet this 1 hr charge time requirement, LCO cathode thicknesses would be required to be maintained at a thickness below 10 μm, where the capacity of the battery (e.g., FIG. 3) comprising a less than 10 μm thick cathode is less than half the capacity of the maximum potential for this material set (517 mAhr/cm³), since a large proportion of space is dedicated to inactive current collector and electrolyte materials.

The slow rate of Li transport through cathode material also increases cost of manufacture of a battery having an absolute capacity target. Rates of manufacturing processes commonly used to make to battery electrodes (e.g., such as tape casting and calendaring) are controlled by area. The rates of these processes are independent of electrode thickness. Thicker electrodes are desired (i) to minimize the number of stacked layers required to build capacity in a battery, (ii) to reduce the amount of inactive material in the battery, and (iii) to reduce capital investments in process equipment. Yield is also expected to be greater as the number of stacked layers in a battery is reduced.

As described herein, rapidly-sintered (less than 1 hour), self-supporting, sintered cathodes for lithium batteries are disclosed, the cathodes having: thicknesses optimized to reduce proportion of inactive components in battery structure (e.g., an as-fired thickness between 10 μm and 200 μm), between 5% to 35% of a second phase, and proportions of active cathode material to second phase optimized for high storage capacity and high rates of charge and discharge (e.g., a perimeter-to-surface area ratio between the active cathode material and second phase of greater than 0.4 μm⁻¹). The perimeter-to-surface area ratio is defined as the total length of perimeter, PT, between the active cathode material (e.g., LCO) and (1) the second phase or (2) the region that contains the second phase (e.g., porosity, as measured by image analysis of polished cross-sections), divided by the total area of the cross-section, A. Active cathode materials may include lithium cobaltite (LCO); lithium nickel manganese cobaltite (NMC) (e.g., 111-type (Li(NiMnCo)_{1/3}O₂) and 811-type (LiNi_{0.8}Mn_{0.1}Co_{0.1}O₂)); lithium nickel cobalt aluminate (NCA); lithium iron manganite (LMO), lithium iron phosphate (LFP), or combinations thereof. The second phase may include (1) a porous structure infiltrated with a liquid electrolyte or (2) solid-state Li-ion conductors with lithium ion conductivity exceeding 10⁻⁴ S/cm (e.g., lithium garnet (LLZO), lithium borate (LBO), perovskite-structured materials (e.g., lithium lanthanum titanate (LTO)), doped LISICON-structured materials (e.g., lithium aluminum titanium phosphate (LATP), lithium aluminum germanium phosphate (LAGP)), thio-LISICONs (e.g., Li₁₁AlP₂S₁₂), lithium phosphosulfide (LPS), combinations thereof, or doped variations thereof). In some examples, the second phase may include (3) mixed conductors with lithium diffusivity greater than 10⁻¹⁰ cm²/s (e.g., solid solutions of Nb₂O₅ and WO₃ or other tungstates). Mean size of pores or particles of the second phase enable shorten distances to enable enhanced Li-ion transport in the active cathode material.

Referring generally to the figures, FIG. 3 a schematic, cross-sectional view of a conventional solid-state, thin-film Li-ion battery 100. The battery 100 includes a cathode current collector 102 and an anode current collector 104 deposited onto an inert mechanical support 106. A cathode 108 (e.g., LCO or LMO) is formed onto the cathode current collector 102 and is surrounded by a solid-state electrolyte 110 (e.g., LiPON). An anode 112 is deposited over the electrolyte 110 and over the anode current collector 104. A coating 114 is provided to protect the cathode 108, electrolyte 110, and anode 112. In the conventional battery design, the mechanical support 106 is relied upon for handling during fabrication of the battery 100 and is the platform for the deposition of the cathode 108 and electrolyte 110 layers. The mechanical support 106 typically has a thickness of 50 μm to 100 μm. The mechanical support 106 and the protective coating 114 also provide rigidity in the final package and help prevent damage.

In these conventional batteries 100, the cathode 108 is typically grown to desired thickness by processes such as RF sputtering or pulsed laser deposition. These deposition techniques are one reason why the conventional battery 100 requires the use of mechanical support 106. Such conventional methods produce cathode materials at a rate of <10 μm/hr., which creates a practical and commercial limit to the achievable thicknesses of these conventional cathode materials. As a consequence, thin film micro-batteries have only found applications where small size power sources are needed like smart cards, medical implants, RFID tags, and wireless sensing.

FIG. 2 is a schematic, cross-sectional view depicting a Li-ion battery having a sintered cathode, according to some embodiments. A lithium-ion battery 10 includes a sintered cathode 12, an electrolyte layer or region 14, and an anode 16. In embodiments, the sintered cathode 12 has a thickness of from 10 μm to 200 μm. Advantageously, the sintered cathode 12 mechanically supports the lithium-ion battery 10 such that the sintered cathode 12 is not carried on an inactive mechanical (e.g., zirconia) support. One advantage of this architecture is that inactive components are substantially excluded from the battery structure. That is, while providing the function of a mechanical support, the sintered cathode 12 is still an active component and contributes to the capacity of the battery. Accordingly, the cathode-supported design can give the same overall capacity in a thinner form-factor (i.e., having a reduced thickness than conventional batteries of, for example, FIG. 3), or retaining similar thicknesses as in the conventional batteries, but having a higher net capacity.

Further, the sintered cathode 12 can be used in both solid-state and liquid electrolyte lithium-ion batteries. In particular, in a solid-state battery, the electrolyte layer 14 includes a solid-state electrolyte, such as LiPON, lithium garnet (e.g., LLZO), lithium phosphosulfide, or lithium super ionic conductor (LISICON). More particularly, in a solid-state battery, the electrolyte layer 14 includes a solid-state electrolyte, with a combination of lithium ion conductivity (e.g., >10⁻⁴ S/cm) and thickness (e.g., <50 μm) such that the area-specific resistance is less than about 50 Ωcm². One advantage of LiPON, in particular, is that it is resistant to dendrite formation. In a liquid electrolyte battery, the electrolyte layer 14 includes a liquid electrolyte (e.g., lithium hexafluorophosphate (LiPF₆), lithium tetrafluoroborate (LiBF₄), lithium bisoxalto borate (LiBOB), lithium difluorooxalto borate (LiDFOB), lithium trifluorosulfonylimide (LiTFSI) or combinations thereof, in carbonate solvent such as ethylene carbonate (EC), dimethyl carbonate (DMC), propylene carbonate (PC) or mixtures thereof), and a polymer or ceramic separator to separate the cathode 12 and anode 16. In either case, the sintered cathode 12 increases the charge capacity over conventional lithium-ion batteries.

Battery 10 also includes a first current collector 18 disposed on a first surface of the sintered cathode 12. In the embodiment depicted, a second current collector 20 is disposed on the anode 16; however, in embodiments, the anode may be a metal (e.g., lithium metal or magnesium metal) in which case a current collector may be excluded. In some embodiments, the sintered anode 16 may include at least one of lithium titanate or lithium niobium tungstate. Further, in the embodiment depicted, the battery 10 is encased in a protective coating 22. In embodiments, the first current collector 18 is copper, and the second current collector 20 (when used) is aluminum. The protective coating 22 may be, e.g., parylene.

While the depicted embodiment only includes a sintered cathode 12, the anode 16 may also be a sintered electrode according to the present disclosure. For a lithium-ion battery, some embodiments of the sintered cathode 12 may include at least one of lithium cobaltite, lithium manganite spinel, lithium nickel cobalt aluminate, lithium iron phosphate, lithium cobalt phosphate, lithium nickel manganate, lithium titanium sulfide, or combinations thereof.

In some lithium-ion batteries, the cathode 12 may be a rapidly-sintered, self-supporting, sintered cathode comprising active materials selected from: lithium cobaltite (LCO), lithium nickel manganese cobaltite (NMC), lithium manganite spinel, lithium nickel cobalt aluminate (NCA), lithium iron manganite (LMO), lithium iron phosphate (LFP), lithium cobalt phosphate, lithium nickel manganate, or lithium titanium sulfide, or combinations thereof, and a second phase selected from: (1) a porous structure infiltrated with a liquid electrolyte or (2) solid-state Li-ion conductors with lithium ion conductivity exceeding 10⁻⁴ S/cm (e.g., lithium garnet (LLZO), lithium borate (LBO), perovskite-structured materials (e.g., lithium lanthanum titanate (LTO)), doped LISICON-structured materials (e.g., lithium aluminum titanium phosphate (LATP), lithium aluminum germanium phosphate (LAGP)), thio-LISICONs (e.g., Li₁₁AlP₂S₁₂), lithium phosphosulfide (LPS), combinations thereof, or doped variations thereof). Mean size of pores—as in (1)—or particles—as in (2)—of the second phase enable shorten distances to enable enhanced Li-ion transport in the active cathode material. In some examples, the second phase may include (3) mixed conductors with lithium diffusivity greater than 10⁻¹⁰ cm²/s (e.g., solid solutions of Nb₂O₅ and WO₃ or other tungstates).

Importantly, the sintered cathode 12 comprises at least one of: (A) thicknesses optimized to reduce proportion of inactive components in battery structure (e.g., an as-fired thickness between 10 μm and 200 μm), (B) between 5% to 25% of a second phase, (C) proportions of active cathode material to second phase optimized for high storage capacity and high rates of charge and discharge (e.g., a perimeter-to-surface area ratio between the active cathode material and second phase of greater than 0.4 μm⁻¹), and (D) a cross-sectional area of at least 3 cm². The cross-sectional area is defined as the area of the face contacting a solid electrolyte separator or porous separator.

Additionally, while a lithium-ion battery is depicted, the battery could instead be based on sodium-ion, calcium-ion, or magnesium-ion chemistries. For a sodium-ion battery, the (sintered) cathode 12 may include at least one of NaMnO₂, Na_{2/3}Mn_{1-y}Mg_{y}O₂ (0<y<1), or NaVPO₄F, and the (sintered) anode 16 may include at least one of Na₂Li₂Ti₅O₁₂ or Na₂Ti₃O₇. For a magnesium-ion battery, the (sintered) cathode 12 may include at least one of MgCr₂O₄ or MgMn₂O₄, and the anode 16 may magnesium metal (which could also serve as the current collector 20). Any of the foregoing battery chemistries may utilize a liquid electrolyte comprising a solvent (e.g., DMC) and a salt with a cation matching the intercalant ion. Additionally, for a sodium-ion battery, sodium super ionic conductor (NASICON) may be used as a solid-state electrolyte.

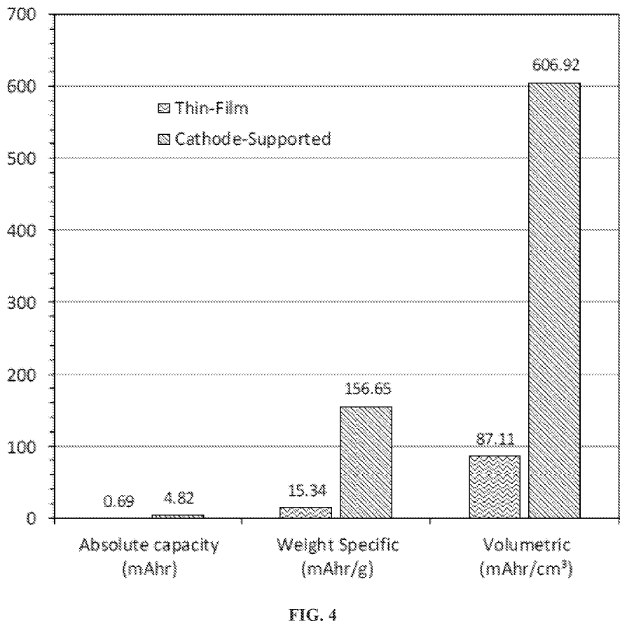

A comparison of the charge capacity of battery 10 of FIG. 2 according to the present disclosure and the charge capacity of conventional battery 100 of FIG. 3 is shown in FIG. 4. The comparison is made at nominally identical thicknesses of 80 μm. In particular, the comparison is made between (1) a conventional battery 100 having a 50 μm thick mechanical support 106 of zirconia and a cathode that is 5 μm thick and (2) the presently disclosed battery 10 having a cathode 12 that is 35 μm thick. Notably, the thickness of the cathode 12 of the presently disclosed battery 10 is less than the thickness of the mechanical support 106 of the conventional battery 100, allowing space to be reserved for lithium metal at the anode 16. As can be seen in FIG. 4, the extra thickness of the sintered cathode 12 and removal of the mechanical support 106 provides a seven-fold higher capacity in absolute and volumetric terms, and the capacity is ten-fold greater on a weight basis.

### General Description of Sintered Electrode & Method of Formation Thereof

Various embodiments of a sintered electrode may include at least one of an alkali metal, an alkaline earth metal, or a transition metal. The sintered electrode comprises at least one of: (A) thicknesses optimized to reduce proportion of inactive components in battery structure (e.g., an as-fired thickness between 10 μm and 200 μm), (B) between 5% to 35% of a second phase, (C) proportions of active electrode material to second phase optimized for high storage capacity and high rates of charge and discharge (e.g., a perimeter-to-surface area ratio between the active electrode material and second phase of greater than 0.4 μm⁻¹), and (D) a cross-sectional area of at least 3 cm². Compared to conventional electrode materials, the sintered electrode can be made much larger and self-supporting than typical thin-film formed electrodes and is usable without any additional finishing techniques, such as grinding or polishing, in contrast to other sintered electrodes.

The sintered electrodes disclosed herein are envisioned to be suitable for a variety of battery chemistries, including lithium-ion, sodium-ion, and magnesium-ion batteries as well those using solid state or liquid electrolyte. Various embodiments of the sintered electrode, manufacturing process, and lithium-ion batteries are disclosed herein. Such embodiments are provided by way of example and not by way of limitation.

As mentioned, various embodiments of a sintered electrode comprise at least one of an alkali metal (e.g., lithium, sodium, potassium, etc.), an alkaline earth metal (e.g., magnesium, calcium, strontium, etc.) or a transition metal (e.g., cobalt, manganese, nickel, niobium, tantalum, vanadium, titanium, copper, chromium, tungsten, molybdenum, tin, germanium, antimony, bismuth, iron, etc.). In some embodiments, the sintered electrode may include oxide, sulfide, selenide, or fluoride compound(s).

In some embodiments, the sintered electrode may comprise: lithium cobaltite (LCO), lithium nickel manganese cobaltite (NMC), lithium manganite spinel (LMO), lithium nickel cobalt aluminate (NCA), lithium iron manganite (LMO), lithium iron phosphate (LFP), lithium cobalt phosphate, lithium nickel manganate, lithium titanium sulfide (LiTiS₂), lithium titanate, lithium niobium tungstate, or combinations thereof. In some embodiments, the sintered electrode may comprise: NaVPO₄F, NaMnO₂, Na_{2/3}Mn_{1-y}Mg_{y}O₂ (0<y<1), Na₂Li₂Ti₅O₁₂, Na₂Ti₃O₇, or combinations thereof. In some embodiments, the sintered electrode may comprise: magnesiochromite (MgCr₂O₄), MgMn₂O₄, or combinations thereof.

In embodiments, the sintered electrode may comprise multiple phases, such as a second phase, a third phase, a fourth phase, etc. intermixed with the first phase. In some embodiments, the additional phase(s) are selected to provide additional functionality. In one example, for a lithium electrode, a second (e.g., lithium garnet) phase may enhance the effective lithium conductivity of the electrode. In some embodiments, the second phase enhances electronic conductivity. The additional phase(s) can be added prior to sintering, or the sintered electrode may contain open porosity that may be infiltrated with the additional phase(s). In some embodiments, the second phase is a spinel that provides additional electronic conductivity.

In some embodiments, the sintered electrodes may be made larger than traditional electrodes for batteries, such as those made using thin-film techniques. For example, sintered electrode thickness may be in a range of 10 μm to 200 μm, or 20 μm and 175 μm, or 50 μm and 150 μm, or 75 μm and 125 μm, or 10 μm and 75 μm, or 15 μm and 65 μm, or 20 μm and 50 μm, or 25 μm and 40 μm, or 125 μm and 200 μm, or 140 μm and 180 μm, or 150 μm and 175 μm, or any values or ranges disclosed therein. In some examples, the sintered electrode may comprise a second phase present in a range of 1% to 50%, or 2% to 40%, or 5% to 35%, or 10% to 30%, or 5% to 40%, or 5% to 30%, or 5% to 25%, or 10% to 40%, or 25% to 40%, or any values or ranges disclosed therein. In some examples, the sintered electrode may comprise a perimeter-to-surface area ratio between the active electrode material and second phase of greater than 0.4 μm⁻¹, or greater than 1 μm⁻¹, or greater than 2 μm⁻¹, or greater than 3 μm⁻¹, or greater than 4 μm⁻¹ or greater than 6 μm⁻¹, or any values or ranges disclosed therein.

Besides being thicker than thin-film electrodes, the sintered electrode can also be made with a relatively larger cross-sectional area. In some examples, the sintered electrode has a cross-sectional area of at least 3 cm², or at least 5 cm², or at least 10 cm², or at least 25 cm², or at least 50 cm², or at least 100 cm², or at least 250 cm², or at least 500 cm², or at least 750 cm², or at least 1000 cm², or any values or ranges disclosed therein. In some examples, the sintered electrode has a cross-sectional area in a range of 3 cm² to 25 cm², or 25 cm² to 100 cm², or 100 cm² to 500 cm², or 500 cm² to 1000 cm², or any value or range disclosed therein. The cross-sectional area is defined as the area of the face contacting a solid electrolyte separator or porous separator.

The disclosed sintered electrodes are able to achieve these advantages through a tape manufacturing process that allows for much faster manufacturing speeds of “medium” thickness electrode materials in which processing speed is independent of electrode thickness. That is, the electrodes can be made thicker than conventional electrodes made through thin film techniques and thinner than other sintered electrodes that have to be ground down to usable sizes. Moreover, the electrode can be rapidly sintered in a more economical process than is currently used for manufacturing electrode materials. Indeed, conventional processes typically utilize thin film techniques that are much slower (e.g., at least 15 hours) and more difficult to build up thick layers. In this way, the relatively thicker sintered electrodes of the present disclose not only eliminate inactive components, such as mechanical supports, but also increase the charge capacity of the battery. Moreover, the thickness of the electrode and tape-casting manufacturing process allow for electrode materials to be manufactured in a roll-to-roll format.

The sintered electrode is able to be made larger than conventional thin-film electrodes because the electrode is formed from a tape cast or extruded green tape that is rapidly sintered. In order to form the green tape, a slurry (or paste) is prepared from a powder component, a binder, and a solvent. The powder component includes a powdered compound(s) comprising at least one of an alkali metal, an alkaline earth metal, or a transition metal. For example, the powder component may include at least one of Li₂O, Li₂CO₃, LiOH, LiNO₃, lithium acetate (CH₃COOLi), lithium citrate (Li₃C₆H₅O₇), MnO₂, Mn₂O₃, Co₂O₃, CoO, NiO, Ni₂O₃, Fe₂O₃, Fe₃O₄, FeO, TiO₂, Nb₂O₅, V₂O₅, VO₂, Ta₂O₅, WO₃, or combinations thereof. In some examples, the powder component of the slurry or paste comprises from 40 wt. % to 75 wt. %, or 45 wt. % to 70 wt. %, or 50 wt. % to 65 wt. %, or 40 wt. % to 60 wt. %, or 50 wt. % to 70 wt. %, by weight of the slurry (or paste), or any values or ranges disclosed therein.

The binder component of the slurry or paste is provided to hold the powder component together in a form of a green tape prior to sintering. The binder may be at least one of polyvinyl butyral (PVB) (e.g., Butvar® PVB resins, available from Eastman Chemical Company), acrylic polymers (e.g., Elvacite® acrylic resins, available from Lucite International), or polyvinyl alcohol, or combinations thereof. The slurry (or paste) is also provided with a solvent (e.g., 1-Methoxy-2-propanyl acetate (MPA), ethanol-butanol mixture, etc.) in which the powder component and binder are dispersed. In some examples, the solvent is non-polar with a dielectric constant at 20° C. of less than 20, or less than 10, or less than 5, or any values or ranges disclosed therein.

In some examples, the chemistry of the binder may be adjusted to work with non-polar solvents, such as MPA. For example, Butvar® B-79 is a commercially available PVB that has a low concentration of hydroxyl groups from polyvinyl alcohol (11-13% by weight) and, compared to other PVB binders, has a low molecular weight. This allows for ease of dissolution and high solubility to control viscosity and enable a high loading of solids.

In some examples, the slurry (or paste) may contain other additives that aid in processing. For example, the additives may include between 0.1% to 5% by weight of a dispersant (e.g., fish-oil dispersant) and/or of a plasticizer (e.g., dibutyl phthalate). Other optional additives include antioxidants, such as a phenol (e.g., butylated hydroxytoluene (BHT) or alkylated-diphenylamine), or materials with an endothermic decomposition like inorganic carbonates and hydroxides.

The slurry (or paste) is tape cast or extruded into a green tape having the desired thickness of the sintered electrode. In embodiments, the green tape is dried to remove a substantial portion of the solvent, leaving primarily the alkali metal, alkaline earth metal, and/or transition metal compound and the binder. Drying occurs at ambient temperature or at a slightly elevated temperature of 60° C. to 80° C. (or begin at an ambient temperature and transition to an elevated temperature), optionally, under a circulated air environment.

The amount of organic material remaining after drying is no more than 10% by weight of the dried green tape. Upon drying the green tape is de-bound and sintered. De-binding is where the green tape is heated to a temperature at which the polymer binder and any other organics are burned off (e.g., 175° C. to 350° C.). Thereafter, the dried and de-bound green tape is continuously sintered. Sintering generally occurs in the temperature range of 500° C. to 1350° C. for a time in a range of less than 60 minutes, or less than 55 minutes, or less than 50 minutes, or less than 45 minutes, or less than 40 minutes, or less than 35 minutes, or less than 30 minutes, or less than 25 minutes, or less than 20 minutes, or less than 15 minutes, or any values or ranges disclosed therein.

As a result of sintering, in embodiments, the sintered electrode has on average a grain size of 10 nm to 50 μm, 50 nm to 25 μm, 100 nm to 10 μm, 1 μm to 5 μm, or any values or ranges disclosed therein. In some examples, the sintered electrode has an open porosity (where the porosity is a second phase in which the second phase is a continuous phase in the solid first phase) such that fluid communication is provided between a first surface of the sintered electrode to the other surface.

Additionally, pores of the sintered electrode tape may be substantially aligned to promote ion transport—i.e., the pores are aligned along an axis perpendicular to the first and second surfaces. For example, each pore may have a cross-sectional dimension that is longer than any other cross-sectional dimension of the pore, and the longer cross-section dimension is substantially aligned perpendicularly to the first and second surfaces of the electrode, e.g., on average, aligned to within 25° of perpendicular.

In contrast to other sintered electrodes, the sintering process described herein produces a sintered electrode that requires no further finishing, such as mechanical grinding or polishing, prior to incorporating into a battery architecture. In particular, previous sintered electrodes were formed from large discs at much greater thicknesses, e.g., 500 μm to 1 mm, and had to be diced to usable dimensions and ground down to a usable thickness. Such grinding has reportedly only been able to achieve a thickness of about 130 μm, which is the practical limit for electrodes manufactured according to conventional sintering processes. By tape-casting the electrode as described presently, not only is the process made more economical (e.g., no grinding/polishing steps and ability to utilize roll-to-roll fabrication), but also desirable thicknesses of the electrode material can be achieved.

### EXAMPLES

### Example 1—Tape Casting Process

Self-supporting LCO cathode ribbons with thicknesses of 45 μm to 85 μm that demonstrate the problem of slow transport in cathode materials and the benefits of a second conducting phase were prepared by rapid sintering of tapes. LCO powders to make the tapes were purchased from Shandong Gelon Lib Co., Ltd. (P1) and American Elements (P2), both of which are LiCoO₂. Compositions are nominally the same, but the morphology and ultimate particle size of each sample differ. Morphology and particle size were selected as a means—beyond adjustment of sintering conditions—to manipulate microstructure. Although the mean particle size of powder P2 in the as-received state is coarser than P1, it can be ground more quickly. For example, the mean particle size of P2 particles (0.76 μm) is roughly half the mean size of P1 particles (1.36 μm) after attrition milling for 5 hours in ethanol with a 2 mm diameter milling media.

Formulations of the slips (i.e., “slurry”; input to the tape casting process) for tape casting are shown in Table 2 below.

TABLE 2

| | Weight Percentages | | |
|---|---|---|---|
| Slip Components | T1 | T2 | T3 |
| Particle1: LCO P1 | — | — | 64.96 |
| Particle2: LCO P2 | 67.04 | 66.05 | — |
| Solvent: 1-Methoxy-2-propanyl acetate (MPA) | 29.98 | 31.01 | 32.09 |
| Dispersant: Fish-Oil | 0.59 | 0.61 | 0.063 |
| Plasticizer: Dibutyl phthalate | 0.59 | 0.61 | 0.063 |
| Binder: Polyvinyl butyral (Butvar B-79) | 1.79 | 1.71 | 1.69 |
| Total non-volatile organics without MPA | 2.97 | 2.94 | 2.96 |

Components of the slips were simultaneously mixed and attrition-milled under equivalent operating environments. Mean particle sizes for P1 and P2 are expected to be consistent with the attrition milling studies conducted for 5 hours in ethanol with a 2 mm diameter milling media, as described above—roughly 1.36 μm for P1 and roughly 0.76 μm for P2. The slips were cast using a gravity fed slot die having a width of about 50.8 mm. Gate heights (i.e., distance between the carrier and the top of the gate, which defines the space the slip flows through during tape casting) were set to range between 8 mil and 12 mil. Casting was made on Mylar carrier. A notable feature of these slips and tapes is that the concentrations of non-volatile organics is low to inhibit flammability of the tape.

Strips measuring approximately 200 mm in length were sectioned from rolls of dried tape and continuously pulled at a rate of 2.5 in/min or 4 in/min through a sintering furnace, which comprises an 11-inch long binder burn-out zone (for removal of binder) and a 40-mm long, single-pass, tube furnace operating of firing temperatures of 1000° C. to 1200° C. Organic binders are more than 80% pyrolyzed on a weight basis by 300° C. and almost entirely eliminated (99%) by 800° C. The total time for this continuous sintering process, which includes heating of the tape, soaking, and cooling, is less than 30 min for all cases. Soak time is the duration of time spent at the sintering set point temperature. Processing attributes, properties and designations for the rapidly fired LCO ribbons are shown in Table 3 below.

TABLE 3

| Condition or Attribute | E1 | E2 | E3 | E4 |
|---|---|---|---|---|
| Tape | T1 | T1 | T2 | T3 |
| Firing temperature (° C.) | 1100 | 1050 | 1050 | 1075 |
| Pull speed (in/min) | 4 | 4 | 2.5 | 2.5 |
| Porosity (%) | 1.2 | 20.1 | 20.5 | 20.2 |
| Thickness (μm) | 47 | 63 | 68 | 81 |
| Perimeter-to-surface area | 0.32 | 1.96 | 1.29 | 0.93 |
| ratio (μm⁻¹) | | | | |

### Example 2—Attribute Characterization

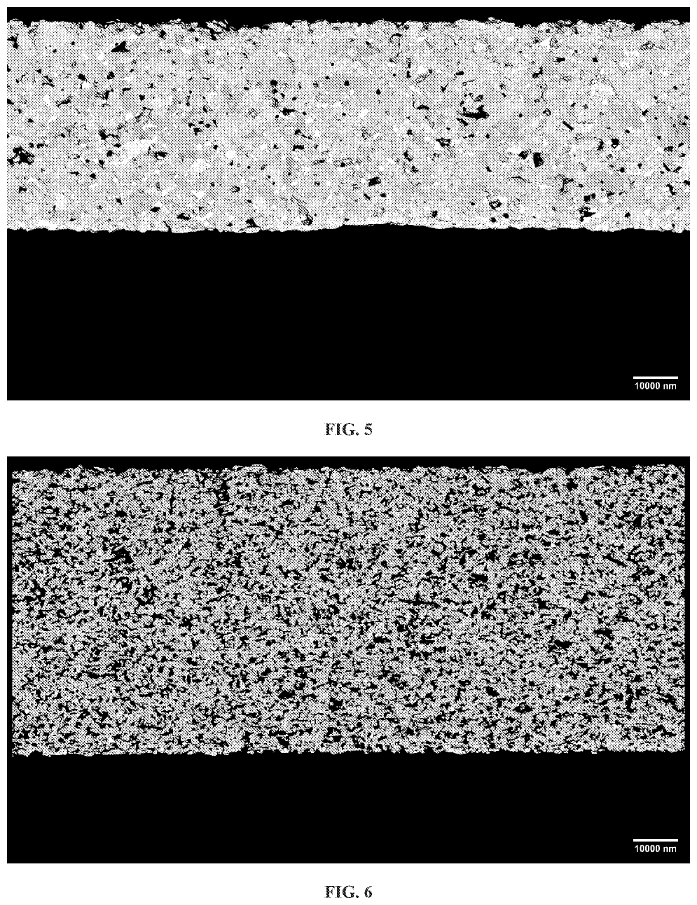

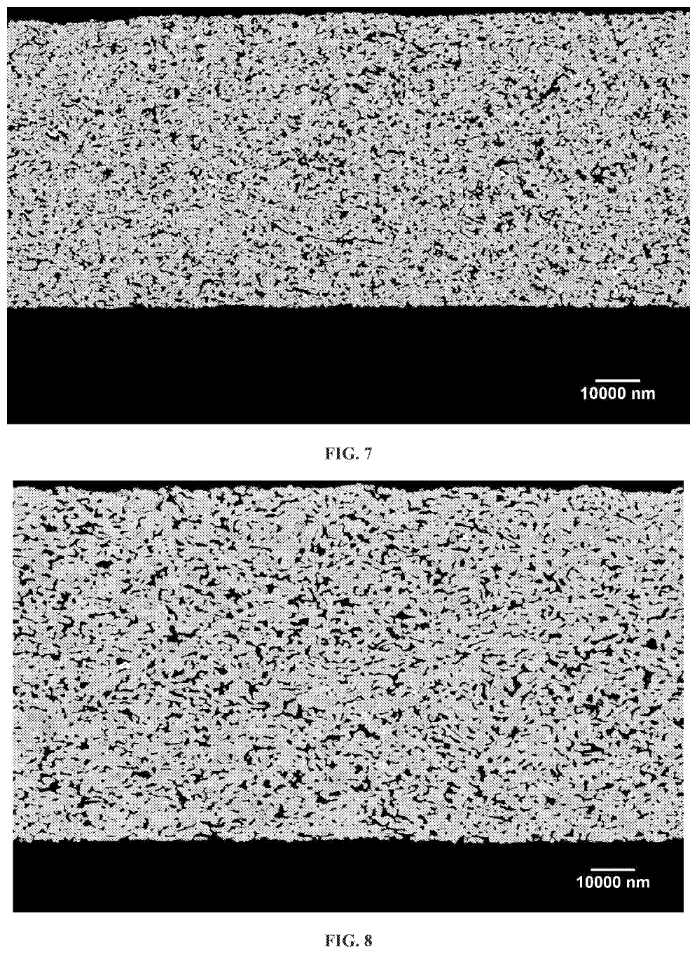

Three disks measuring 12.3 mm in diameter were laser cut from each of the E1-E4 LCO ribbons (for a total of 12 samples), two of which were evaluated as cathodes in coin cells (8 samples) and one which was selected for scanning electron microscopy (SEM) analysis (4 samples). Attributes of the (1) thickness, (2) porosity, and (3) ratio of perimeter length of the LCO-pore interface to the total cathode structure area were determined by analysis of high resolution SEM images of polished cross-sections for E1-E4, as in FIGS. 5-8, respectively. Quantification of FIGS. 5-8 for (1)-(3) are provided in Table 3 above.

CR2032 coin cells were assembled with a 14 mm diameter chip of lithium as the anode and a 17 mm diameter porous glass fiber filter from Whatman as the separator. The liquid electrolyte was 1M LiPF₆ in a 1:1 mixture of ethylene carbonate and dimethyl carbonate solution. Three charge-discharge cycles were conducted at C-rates of 0.1, 0.3, 0.5, 0.8 and 1 with currents chosen based upon the theoretical capacity of LCO being 137 mAhr/g. Charging was performed under constant-current and then constant-voltage conditions between 3.0V and 4.3V. Charging was terminated and discharging initiated once the current reached 10% of the C-rate value. Constant current conditions were used for discharging.

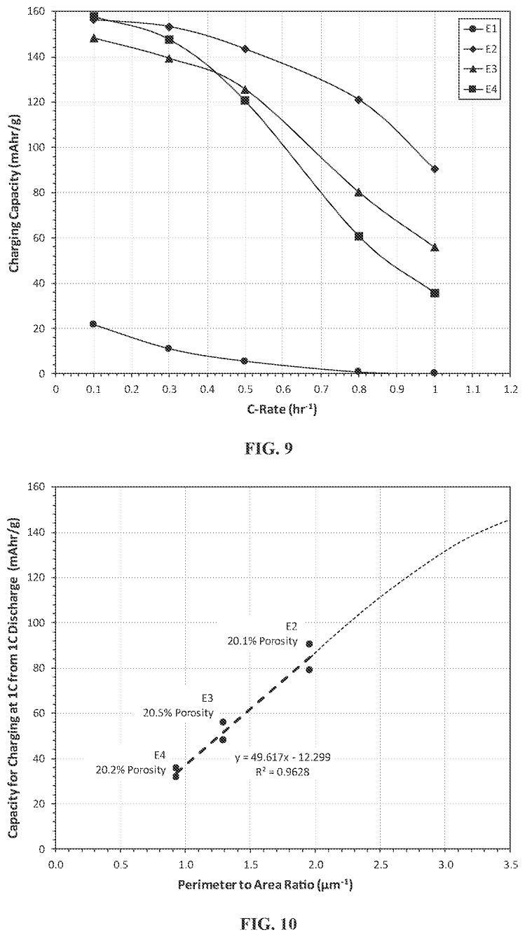

FIG. 9 illustrates charging capacity as a function of charging speed for samples E1-E4, according to some embodiments. The problem of slow lithium transport in the active cathode material is immediately apparent in the capacity of the cells fabricated with disks from the E1 ribbon. Even at a C-rate of 0.1, the capacity barely exceeds 20 mAhr/g and is less than 15% of the theoretical 137 mAhr/g. Porosity of the E1 ribbon is low (less than 2%), and the SEM image in FIG. 5 strongly suggests that its pores are completely closed (widely scattered black voids). Liquid electrolyte is not able to infiltrate the E1 ribbon structure.

Capacities of cells fabricated with disks from the E2-E4 ribbons increased dramatically by microstructural optimization. These disks all have porosities ranging from about 20-22%, whereby the pores are open and can be infiltrated by the liquid electrolyte. The liquid electrolyte provides a faster path for lithium ion conduction into or out of (i.e., through) the cathode structure. Capacities of cells with the improved E2-E4 ribbon microstructure charged at 0.1 C-rate are seven-fold higher than cells with LCO from E1 ribbon, all of which range between 150 mAhr/g to 160 mAhr/g. Note, charging at 4.3V leads to a capacity that is a few percent higher than theoretical. In addition, E2-E4 are thicker than the E1. Areal capacity of an electrode increases with its thickness and as a result, a proportionately larger current density is needed to charge at a given C-rate. Thicknesses of E2-E4 were made to limit this effect. E1 illustrates the need for a second phase; despite being thinner than E2-E4, E1 capacity is lower at all C-rates. Thus, the amount of second phase is more important than cathode thickness, in some embodiments.

The capacities for charging the LCO disks comprising E2-E4 ribbons indicate a strong trend with microstructure as the charging speed increases. FIG. 10 illustrates charging capacity at 1 C rate as a function of perimeter-to-surface area ratio at nominally constant porosity for samples E2-E4, according to some embodiments. Specifically, the capacity at 1 C rate is quantified as a function of the ratio of the perimeter length between the active LCO and pores to the total area of the cathode structure.

The perimeter-to-surface area ratio is defined as the total length of perimeter, PT, between the active cathode material (e.g., LCO) and (1) the second phase or (2) the region that contains the second phase (e.g., porosity, as measured by image analysis of polished cross-sections), divided by the total area of the cross-section, A. The perimeter-to-surface area ratio is a surrogate for and is directly proportionate to surface-to-volume ratio. Thus, any trend observed for perimeter-to-surface area ratios is equivalently applicable for surface-to-volume ratios. The trend of increasing capacity with higher perimeter-to-surface area ratio (and likewise, for higher surface-to-volume ratios) may be because local distances for transport of lithium ions in-and-out of the active cathode material decreases as the surface-to-volume ratio increases for a fixed porosity. There is greater area for charge transfer reaction in the cathode as the surface-to-volume ratio grows. Theory is confirmed by data, as the E2 ribbon, which has the highest perimeter-to-surface area ratio between E1-E4, also demonstrates the highest capacity in FIG. 10.

Microstructures of E2-E4 have an optimal amount of second phase, about 10-25%, as well as having a high surface-to-volume (perimeter-to-surface area) ratio of greater than 0.4 μm⁻¹. FIG. 11 illustrates modeled capacity at 1 C rate for a 67 μm thick LCO electrode as a function of concentration of conducting secondary phase (e.g., where the conducting secondary phase is porosity) with a conductivity of 1M LiPF₆ in organic carbonate solution. Values for model parameters for the components including LCO were collected from the scientific literature. Capacity was calculated for a 67 μm thick cathode structure for two pore diameters, 1 μm and 3 μm, at 1 C rate under the same constant-current and constant-voltage conditions as described above. The available capacity on charging rises rapidly as porosity is introduced into the cathode; local distances for lithium transport through the LCO are shortened and area for charge transfer increases. The available capacity peaks and thereafter decreases because after a tipping point concentration of porosity, adding more porosity only serves to decrease the amount of LCO in the cathode structure past a critical threshold value. The optimal volume percentage of secondary conductive liquid phase is approximately between about 10 and 25% and is highlighted grey in FIG. 11. Capacity in this highlighted region is greatest and changes relatively slowly as a function of volume percentage of the second phase. Moreover, the capacity in the highlighted region is ideal for battery performance and process for control of microstructure. FIG. 11 also shows the beneficial impact of increasing the surface-to-volume ratio by reducing the size of the pores or alternatively, size of the regions of secondary lithium ion conducting phase. As experimentally demonstrated above for E1-E4 samples, the model confirms that charging capacity is greater for higher surface-to-volume ratios.

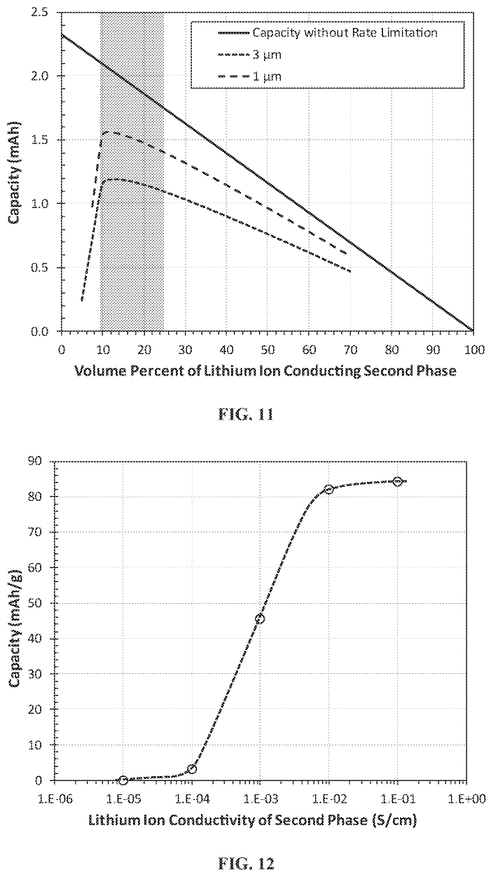

While FIG. 11 models the case where the conducting secondary phase is porosity, this approach may be extended to include lithium ion conducting secondary phases that are solid for all solid-state batteries. FIG. 12 illustrates modeled capacity at 1 C rate for a sintered LCO cathode as a function of lithium-ion conductivity of the second phase. Specifically, charging capacity at a 1 C rate was modeled for a 67 μm thick LCO cathode with 15% by volume of secondary phase lithium ion conductor as a function of the lithium ion conductivity of second phase. The secondary lithium ion conductor enables rapid transport of lithium through the cathode structure when its conductivity rises above about 10⁻⁴ S/cm.

The optimal microstructures in the above examples were realized by tuning particle size, particle packing and sintering conditions. Further improvements in the microstructure, can be realized according to FIG. 11 by increasing the surface-to-volume ratio by utilizing cathode particles of finer sizes by grinding for longer periods of time or using cathode materials from processes like flame pyrolysis that are naturally small (e.g., less than 300 nm).

One challenge in developing structures such as those disclosed herein is to maintain continuity of second phase below certain threshold concentration values. One way to address this challenge might be to ensure that the average particle size of solid secondary lithium ion conducting phase is smaller than the average particle size of the active cathode material. Smaller size secondary particles tend to accumulate at interstices between the cathode particles where they are able to link and form a continuous network. Particles size of cathode materials may also be used to maintain continuity of porosity for infiltration with a liquid. A particle size distribution with significant fraction of fine particles (e.g., d₁₀<200 nm) is beneficial because packing density may be increased and because the fine components will sinter and bond larger particles together while maintaining a continuous pore network.

The disclosed electrode is beneficial to performance of all solid-state batteries and process for making them in the following ways: (A) proportions of active cathode material and second phase are optimized to give both high storage capacity for high rates of charge and discharge, 1 C in a cathode structure with a thickness of greater than 20 μm; (B) the defined mean size of the pores or particles of second phase shorten distances for transport of lithium in the active cathode material; (C) the internal surface area between electrolyte and active cathode material is increased relative to a flat electrode-electrolyte interface so the contribution of charge transfer to total cell resistance is reduced; (D) thicker cathode structures reduces the proportion of inactive components in the battery and the cathode can also function as a free-standing substrate for deposition of thin solid electrolytes (e.g., LLZO or LiPON) via thin film deposition, spray coating, and casting to thicknesses of 10 μm or less; (E) an absolute capacity target for a battery can be achieved with less cell area, i.e. fewer layers or windings in pouch or cylindrical cells, respectively; (F) thicker cathodes are structurally less fragile and more easily fabricated, handled, and assembled into a battery; and (G) with a rapid, continuous sintering process for co-firing the active cathode material and lithium ion conducting second phase, as explained above, there are less unwanted reactions.

Specifically to (D), because the sintered electrode is self-supporting, the sintered electrode can be used as a substrate for deposition of additional layers. For example, a metallic layer (e.g., up to 15 μm) can be deposited onto a surface of the sintered electrode to serve as a current collector for a battery. Additionally, in some examples, a solid electrolyte, such as lithium-phosphorous-oxynitride (LiPON), lithium garnet (e.g., garnet LLZO (Li₇La₃Zr₂O₁₂)), or lithium phosphosulfide, may be deposited by RF-sputtering onto the sintered electrode. Alternatively, a thin layer of LiPON solid electrolyte can be applied through ammonolysis of a thin layer of Li₃PO₄ or LiPO₃ or through reactive sintering. Such processes are envisioned to be faster and potentially less capital intensive than conventional deposition techniques for solid electrolytes. Similarly, a solid electrolyte of lithium garnet (e.g., LLZO) can be applied by sol-gel, direct sintering, and reactive sintering.

Further, as a self-supporting layer, the sintered electrode can provide the basis for an advantaged manufacturing approach for lithium batteries that use a liquid electrolyte. In other words, the cathode (i.e., sintered electrode) is a substrate of the battery. In particular, the sintered electrode can be made in a continuous process and used as a substrate for coating in either batch or roll-to-roll processing. Such processing could allow, for example, metallization of the sintered electrode by sputtering and/or electrolytic deposition to form a metallized sintered electrode. In this way, the thickness of the electrode current collector metal can for a conventional lithium battery can be reduced from the typical thickness of 10-15 μm to less than 5 μm, less than 1 μm, or even less than 100 nm. Further, the metallized sintered electrode can be supplied in piece or roll form as a stand-alone component to a battery cell manufacturer. Advantageously, such metallized sintered electrodes reduce the volume of the cell typically reserved for the current collector, allowing for more active electrode material and higher capacity.

Besides simply allowing for a larger electrode, the disclosed sintered cathode 12 also provides structural advantages that increase its charge capacity over conventional cathodes. In a calendared cathode 108, the active cathode particles make point contacts. The cross-sectional areas of the contacts are small and so have a high impedance to movement of lithium ions and electrons. In order to overcome this impedance issue, carbon is added to the electrode as a conductive pathway to facilitate transport of electrons into and out of the active particles. The use of carbon in this manner creates a tradeoff between capacity of the battery and charge/charge rate performance. The other issue with the point contacts between the active cathode particles is that they are weak, and so polyvinyl fluoride (PVF) is used to bind the active particles and carbon together to give the structure strength during processing. In contrast, particles in the depicted sintered cathode 12 are bonded to one another, and so, the electronically conductive carbon and binder may be eliminated after sintering. In this way, the proportion of space allocated to porosity for movement of lithium ions may be reduced, and more space can be dedicated to active material with a sintered cathode. The inventors estimate that for a given cathode material, the capacity in aggregate can be raised by approximately 30% on the basis of equal cathode thicknesses. Alternatively, the cathode thickness could be reduced by 20-25% while keeping the capacity the same for a more compact battery. As mentioned above, the pores in the sintered cathode 12 can be aligned in the direction of transport of ions to and from the anode so as to enable further improvements in space utilization or to boost power density.

As used herein, the term “porosity” is described as a percent by volume (e.g., at least 10% by volume, or at least 30% by volume), where the “porosity” refers to the portions of the volume of the sintered article unoccupied by the inorganic material.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

As utilized herein, “optional,” “optionally,” or the like are intended to mean that the subsequently described event or circumstance can or cannot occur, and that the description includes instances where the event or circumstance occurs and instances where it does not occur. The indefinite article “a” or “an” and its corresponding definite article “the” as used herein means at least one, or one or more, unless specified otherwise. References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

With respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

1. A sintered electrode for a battery, the sintered electrode having a first surface positioned to face a current collector and a second surface positioned to face an electrolyte layer, wherein the sintered electrode comprises:
a first phase and a second phase, wherein:
the first phase comprises a lithium compound, and
the second phase comprises at least one of a porous structure or solid-state Li-ion conductors,
and wherein:
a thickness of the sintered electrode between the first surface and the second surface ranges between 10 μm and 200 μm.

2. The sintered electrode of claim 1, wherein the second phase comprises the porous structure, wherein:
the sintered electrode having an open porosity in a range of 5% to 35%, and
the porous structure is continuous within the first phase.

3. The sintered electrode of claim 1, wherein pores of the porous structure are aligned, on average, to within 25° of perpendicular to the first and the second surfaces of the sintered electrode.

4. The sintered electrode of claim 1, wherein the porous structure is infiltrated with a liquid electrolyte.

5. The sintered electrode of claim 4, wherein the liquid electrolyte comprises at least one of lithium hexafluorophosphate (LiPF₆), lithium tetrafluoroborate (LiBF₄), lithium bisoxalto borate (LiBOB), lithium difluorooxalto borate (LiDFOB), lithium trifluorosulfonylimide (LiTFSI) or combinations thereof.

6. The sintered electrode of claim 1, wherein the second phase comprises the solid-state Li-ion conductors present in a range of 5% to 35% by volume of the sintered electrode.

7. The sintered electrode of claim 6, wherein the solid-state Li-ion conductors have a lithium ion conductivity exceeding 10⁻⁴ S/cm.

8. The sintered electrode of claim 6, wherein the solid-state Li-ion conductors are at least one of: lithium garnet (LLZO), lithium borate (LBO), lithium lanthanum titanate (LTO), lithium aluminum titanium phosphate (LATP), lithium aluminum germanium phosphate (LAGP), Li₁₁AlP₂S₁₂, lithium phosphosulfide (LPS), combinations thereof, or doped variations thereof.

9. The sintered electrode of claim 1, wherein the lithium compound comprises at least one of lithium cobaltite (LCO), lithium nickel manganese cobaltite (NMC), lithium manganite spinel, lithium nickel cobalt aluminate (NCA), lithium iron manganite (LMO), lithium iron phosphate (LFP), lithium cobalt phosphate, lithium nickel manganate, lithium titanium sulfide, or combinations thereof.

10. The sintered electrode of claim 1, wherein the sintered electrode is a self-supporting substrate of the battery.

11. The sintered electrode of claim 1, wherein the battery does not comprise an inactive substrate.

12. The sintered electrode of claim 1, wherein a perimeter-to-surface area ratio between the first phase and the second phase is at least 0.4 μm⁻¹.

13. The sintered electrode of claim 1, wherein a cross-sectional area of the sintered electrode is at least 3 cm².

14. A cathode for a battery, comprising:
a first phase and a second phase; and
a first surface and a second surface,
wherein a thickness between the first surface and the second surface is between 10 μm and 200 μm; and
wherein the cathode has at least one of:
an open porosity in a range of 5% to 35%;
a lithium ion conductivity exceeding 10⁻⁴ S/cm; and
a perimeter-to-surface area ratio between the first phase and the second phase of at least 0.4 μm⁻¹.

15. The cathode of claim 14, wherein a cross-sectional area of the sintered cathode is at least 3 cm².

16. A battery, comprising:
the cathode of claim 14;
an electrolyte material penetrating a porous region of the cathode;
wherein the cathode is a substrate of the battery.

17. The battery of claim 16, wherein the electrolyte is selected from:
lithium hexafluorophosphate (LiPF₆), lithium tetrafluoroborate (LiBF₄), lithium bisoxalto borate (LiBOB), lithium difluorooxalto borate (LiDFOB), lithium trifluorosulfonylimide (LiTFSI) or combinations thereof;
lithium garnet (LLZO), lithium borate (LBO), lithium lanthanum titanate (LTO), lithium aluminum titanium phosphate (LATP), lithium aluminum germanium phosphate (LAGP), Li₁₁AlP₂S₁₂, lithium phosphosulfide (LPS), combinations thereof, or doped variations thereof.

18. The battery of claim 16, not including an inactive substrate.

19. The battery of claim 18, wherein a volume of the battery is less than a volume of a battery comprising a cathode disposed over the inactive substrate.
